(19) United States
(12) Patent Application Publication
(10) Pub. No.: US 2013/0258638 A1
(43) Pub. Date: Oct. 3, 2013

(54) WAVELENGTH-CONVERTING STRUCTURE FOR A LIGHT SOURCE

(71) Applicants: Michael Dongxue Wang, Santa Clara, CA (US); Alan Lenef, Belmont, MA (US)

(72) Inventors: Michael Dongxue Wang, Santa Clara, CA (US); Alan Lenef, Belmont, MA (US)

(21) Appl. No.: 13/436,847

(22) Filed: Mar. 31, 2012

(51) Int. Cl. F21V 9/16

(52) U.S. Cl. 362/84

(57) ABSTRACT

A wavelength-converting structure for a light module including a solid-state light source. The wavelength-converting structure includes a pattern of discrete wavelength-converting sections of wavelength-converting material formed therein, wherein each wavelength-converting section is separated from adjacent wavelength-converting sections by at least one transmissive section. The wavelength-converting sections are comprised of a wavelength-converting material such as a phosphor that converts at least a portion of the light emitted by the solid-state light source into light having a different peak wavelength.

### CROSS-REFERENCE TO RELATED APPLICATIONS

This application is related to co-pending application Attorney Docket No. 2011P24782US filed concurrently herewith.

### FIELD

The present disclosure relates generally to solid-state light sources, and, more particularly, to a light emitting diode (LED) light source including a wavelength-converting structure.

### BACKGROUND

Solid-state lighting may include one or more LEDs, and/or laser diodes, as a source of illumination and provide numerous benefits including, but not limited to, increased efficiency and lifespan. Known LED chips generate visible or non-visible light in a specific region of the light spectrum. The light output from the LED may be, for example, blue, red, green or non-visible ultra-violet (UV) or near-UV, depending on the material composition of the LED. When it is desired to construct an LED light source that produces a color different from the output color of the LED, it is known to convert the LED light output having a peak wavelength (the “primary light” or “excitation light”) to light having a different peak wavelength (the “secondary light” or “emission light”) using photoluminescence.

The photoluminescence process involves absorbing the higher energy primary light by a wavelength-converting material such as a phosphor or mixture of phosphors thereby exciting the phosphor material, which emits the secondary light. The peak wavelength of the secondary light depends on the type of phosphor material, which can be chosen to provide secondary light having a particular peak wavelength. This process may be generally referred to as “wavelength down conversion” and an LED combined with a wavelength-converting structure that includes wavelength-converting material, such as phosphor, to produce secondary light, may be described as a “phosphor-converted LED” or “wavelength-converted LED.”

In a known configuration, an LED die, such as a III-nitride die, is positioned in a reflector cup package and a volume, conformal layer or thin film including a wavelength-converting material is deposited directly on the surface of the die. In another known configuration, the wavelength-converting material may be provided in a solid, self-supporting flat structure, such as a ceramic plate, single crystal plate or thin film structure. Such a plate may be referred to herein as a “wavelength-converting plate.” The plate may be attached directly to the LED, e.g. by wafer bonding, sintering, gluing, etc. Alternatively, the plate may be positioned remotely from the LED by an intermediate element.

One drawback associated with using wavelength-converting plate configurations is that the path length of the primary light inside the plate increases with changes in viewing angle from 0 degrees to the normal (typically defined at 90 degrees to the top surface of the wavelength-converting plate) to higher angles. These effects may contribute to different color light being emitted at angles close to the normal compared to the higher angles and is known as color angular spread or color separation (ΔCx, ΔCy). For example, in the case of a wavelength-converting plate comprised of cerium-activated yttrium aluminum garnet (YAG:Ce) combined with a blue InGaN LED chip, bluer light may be emitted at angles near normal to the chip while yellower light may be emitted at angles far from the normal. In this case, incident primary light (e.g. blue light) may interact over differing optical path lengths as a function of incident angles, ultimately making it difficult to achieve color uniformity. In addition, depending on the processing method and/or properties of the wavelength-converting material of such plates, at least a portion of the primary light and/or secondary light may be lost due to internal reflection, scattering, and/or absorption in the wavelength-converting plate.

Some configurations have attempted to address such color mixing issues by providing methods of combining the LED radiation pattern for the primary light with emission of the converted light from phosphors. For example, in some configurations, a scattering medium (e.g. pores or phosphor particles) may be used to redistribute the primary light radiation pattern to better match the secondary light. However, such configurations are dependent upon the specific properties of the wavelength-converting structure and primary light source. In the case of full conversion of primary light, whereby all or most of the primary light is converted, some configurations include specific optics and/or diffusers to combine the spatially disparate sources of color, which may be difficult, expensive, and ineffective.

Another drawback associated with some wavelength-converting plate configurations is related to multiple internal interfaces of phosphor that may impede heat transfer and therefore dissipation of heat produced by the LED and phosphor materials. In particular, heat generated by Stokes shift in the phosphor material may be difficult to dissipate, and may cause the temperature of the plate structure to rise, thereby reducing conversion efficiency of the phosphor material of such plates. Excess generated heat may further reduce lifespan and/or lumen output of the LED. Some configurations have attempted to address such thermal issues by including heat dissipating structures, such as heat sinks, and/or driving the LEDs with low current.

### BRIEF DESCRIPTION OF THE DRAWINGS

Reference should be made to the following detailed description which should be read in conjunction with the following figures, wherein like numerals represent like parts:

FIG. 1 diagrammatically illustrates in cross section one embodiment of a wavelength-converted LED assembly including a wavelength-converting plate consistent with the present disclosure;

FIG. 2 diagrammatically illustrates in cross section another embodiment of a wavelength-converted LED assembly consistent with the present disclosure;

FIG. 3 diagrammatically illustrates the wavelength-converting plate shown in FIG. 1 in perspective view;

FIG. 4 diagrammatically illustrates another embodiment of a wavelength-converting plate consistent with the present disclosure in perspective view;

FIG. 5 illustrates another embodiment of a wavelength-converting plate in perspective view consistent with the present disclosure; and

FIGS. 6A-6B diagrammatically illustrate in cross section other embodiments of a wavelength-converting plate consistent with the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

References to the color of a phosphor, LED or conversion material refer generally to its emission color unless otherwise specified. Thus, a blue LED emits a blue light, a yellow phosphor emits a yellow light and so on.

### DETAILED DESCRIPTION

By way of a brief overview, the present disclosure features a wavelength-converting plate that includes a pattern of wavelength-converting sections and one or more transmissive sections formed therein. The wavelength-converting plate may be combined into a light module such as a wavelength-converted LED assembly whereby primary light emitted by an LED passes through a bottom surface of the plate and excites wavelength-converting material in the wavelength-converting sections to cause emission of secondary light. The transmissive sections may be configured to allow a primary light emitted by the LED to pass through the plate substantially without conversion to secondary light. The secondary light and primary light may then pass from the wavelength-converting plate through additional optics, such as a diffuser, configured to mix the secondary and primary light to provide light output having improved color uniformity.

A wavelength-converting plate consistent with at least one embodiment of the present disclosure may provide numerous advantages. For example, the specific pattern of wavelength-converting sections may increase the interaction area between the LED light and the wavelength-converting material of the plate. This, in turn, may allow more primary light from the LED to scatter within the plate, resulting in an increase in path lengths and interaction between the primary light and wavelength-converting material, thereby improving conversion efficiency of the primary light to secondary light. In addition, an increase in interaction area may also allow a low concentration of activator ions (luminescent ions) in the wavelength-converting material, resulting in a reduction of ion-ion interactions, thereby increasing conversion efficiency. Finally, scattering and reflection of the primary light within the transmissive sections increase the amount of primary light emitted from the converting plate at higher angles, thereby improving the primary light component in the radiation pattern.

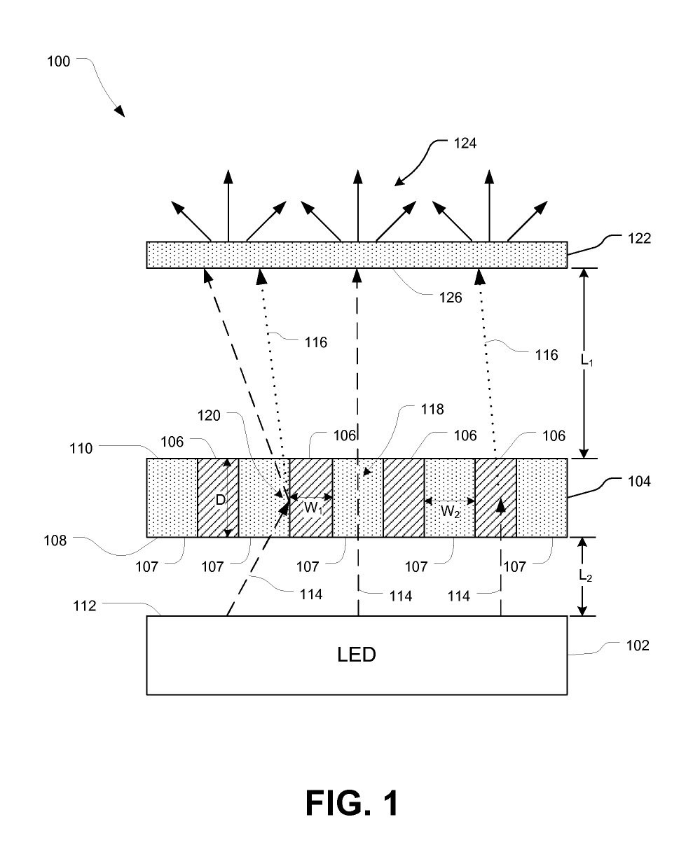

Turning now to the figures, FIG. 1 generally illustrates in cross section one embodiment of a light module configured as a wavelength-converted LED assembly 100 consistent with the present disclosure. The illustrated assembly 100 includes a known LED 102 and a wavelength-converting plate 104 (hereinafter referred to as “plate 104” for ease of description) and a diffuser 122. The wavelength-converting plate 104 may be configured with a pattern of one or more discrete wavelength-converting sections 106 and one or more transmissive sections 107. Each wavelength-converting section 106 may have a defined width W₁ and depth D. As shown, at least some of the wavelength-converting sections 106 extend entirely through a portion of the plate 104 (i.e. from a bottom surface 108 of the plate 104 to a top surface 110 of the plate 104). In other embodiments, some of the wavelength-converting sections 106 extend partially through portions of the plate 104. Similarly, each transmissive section 107 may have a defined width W₂, such that at least two of the wavelength-converting sections 106 are separated from one another by the width W₂ of a transmissive section 107 disposed between.

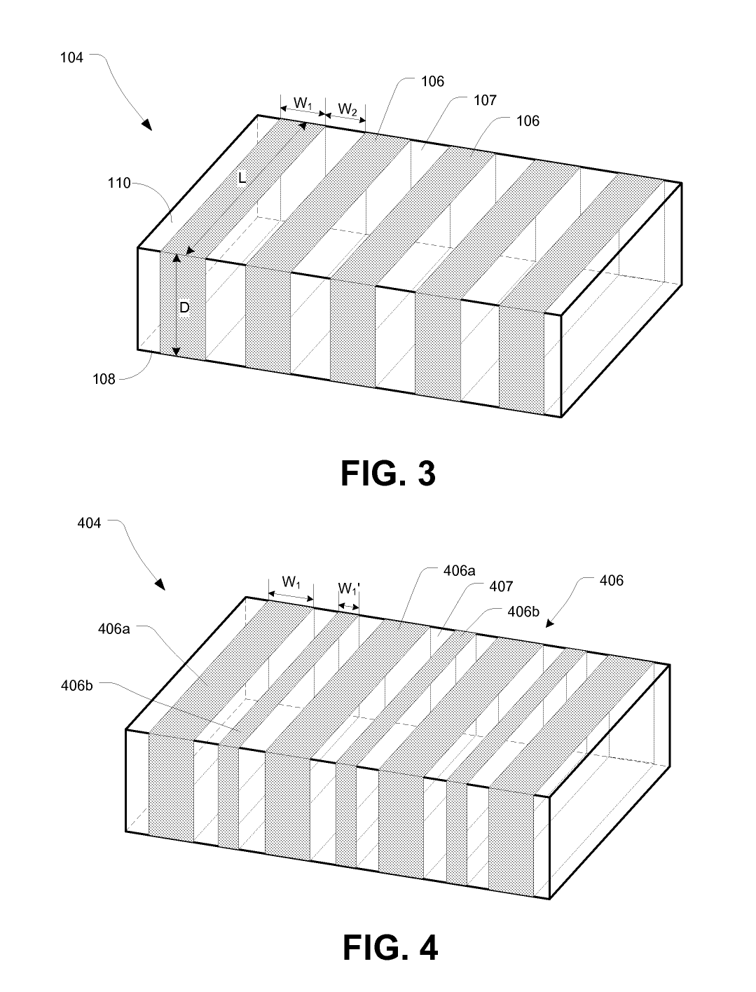

As shown, each wavelength-converting section 106 may be separated from an adjacent section 106 by at least one of the transmissive sections 107, and each wavelength-converting section 106 may have a defined interface between a portion thereof and a transmissive section 107. In one embodiment, a defined interface may exist between the wavelength-converting section 106 and the transmissive section 107 along an entire depth D and length L (shown in FIG. 3) of the section 106. In other embodiments, the defined interface may exist along portions of the depth D and/or length L of the section 106.

The plate 104 may take any known wavelength-converting plate configuration and may be a flat plate, such as a ceramic plate, single crystal plate or thin film structure. Each discrete wavelength-converting section 106 may be constructed using materials and combinations of materials including wavelength-converting material, such as, for example, known phosphors for achieving a desired wavelength conversion, including, but not limited to, yellow phosphor, green phosphor, red phosphor, and/or combinations thereof. Additionally, in some embodiments, some of the sections 106 may include a mixture of multiple types of phosphors (yellow, green, red) arranged in a desired distribution and/or pattern within each section 106. The phosphor may be in the form of phosphor powders dispersed in optical quality silicone or formed as a sintered ceramic. Known phosphors include, but are not limited to, cerium-activated yttrium aluminum garnet (YAG:Ce), cerium-activated lutetium aluminum garnet (LuAG:Ce), europium-activated strontium silicon oxynitride (Sr—SiON:Eu), etc. The use of a combination of phosphor types may provide improved color rendering. Additionally, the particular distribution and/or pattern, as well as size, of the phosphor types can be controlled to achieve desired near-field light distributions, optimal thermal characteristics, as well as improved angular performance.

The transmissive sections 107 may be formed from a solid, optically transparent material, such as silicone, so that primary light imparted thereon may pass through the transmissive section 107 (hereinafter referred to as “transmissive section 107”) without conversion to secondary light. In another embodiment, one or more transmissive sections 107 may include an amount of wavelength-converting material that causes conversion of primary light to secondary light at level that is less than the conversion that occurs in the wavelength converting sections.

The transmissive sections 107 of a plate 104 consistent with the present disclosure may include, but are not limited to, ceramics (e.g. alumina, yttria and yttrium aluminum garnet (YAG), glasses (e.g. silica and fluoride glasses), any known optical-quality plastic (e.g. PMMA (acrylic)), and combinations of such materials. Some transmissive sections 107 may include an optically translucent material and some transmissive sections 107 may include optically transparent material. In some embodiments, some transmissive sections 107 may include a portion having an optically translucent material and a portion having an optically transparent material.

A plate consistent with the present disclosure may include transmissive sections that include a ceramic material, wherein grain boundaries and/or pores within the ceramic material may allow scattering of light emitted by the light source (e.g., an LED). The scattering of light from the light source may be advantageous in that unconverted primary light imparted upon the transmissive section may be scattered and may interact with an adjacent wavelength-converting section. In addition, use of a ceramic material for the transmissive section may also provide high heat conductivity. A plate consistent with the present disclosure may include transmissive sections that include a glass material. Glass materials may provide optical transparency.

The discrete wavelength-converting sections 106 and transmissive sections 107 may be formed within the plate 104 during or after the forming of the plate 104. The plate 104 may be made by a known molding or template method in which a silicone material used to form the transmissive sections 107 and phosphor dispersed in optical quality silicone used to form the wavelength-converting sections 106 are injected into a desired mold or template cell to make a plate including a pattern of discrete wavelength-converting sections 106 and transmissive sections 107. Alternatively, a plate 104 may be made by a known molding or template method without a pattern of one or more discrete wavelength-converting sections 106 and transmissive sections 107 formed therein during the formation process, wherein the pattern of sections 106 and 107 may be later formed by any known etching process. For example, a plate of optically translucent material forming the transmissive sections 107 may be etched to form a pattern of wavelength converting sections 106 with the etching subsequently filled with wavelength-converting material. In another embodiment, a plate of wavelength-converting material, e.g. phosphor, dispersed throughout may be etched to remove phosphor in a desired pattern so as to form the transmissive sections 107 and leave a pattern of wavelength-converting sections 106.

It should be noted that an additional method of fabricating phosphor patterns may include direct incorporation of phosphor into the plate. For example, by using co-sintering techniques, the doped (phosphor) and undoped sections of the plate may be formed from the same material, e.g. YAG, obviating problems with different shrinkage rates during sintering. In another method, rare-earth doped fluoride glasses as a doped fluoride film may be applied to an undoped glass substrate. By using HF etching with masks, a patterned phosphor may be achieved. Plastics are generally less suitable for direct incorporation of phosphor ions, but may be suitable for incorporation of phosphor powders. Patterns may be obtained by multi-component injection molding techniques.

The LED 102 may be any known LED serving as a light source, including, but not limited to a nitride III-V LED such as an InGaN LED. It is to be understood that the assembly 102 may include a single LED 102 or an array of LEDs. Alternatively, or in addition, the assembly 100 may include a laser diode serving as a light source. In another embodiment, the LED and/or laser diode may be coupled with a light guide to form a surface emitter. Preferably, the LED 102 is a blue LED or laser diode that emits in a wavelength range from 420 nm to 490 nm, or even more preferably 450 nm to 475 nm.

The LED 102 emits primary light at a peak wavelength through an emitting surface 112 thereof. The bottom surface 108 of the plate 104 is defined by bottom surfaces of the wavelength-converting sections 106 and transmissive sections 107 and is positioned in opposed facing relationship to the emitting surface 112 of the LED 102. It is to be understood that FIG. 1 is provided in diagrammatic form for ease of illustration and explanation, and, for example, the bottom surface 108 of the wavelength converting plate 104 and the emitting surface 112 the LED 102 may have substantially different (roughened, structured, etc.) character from the indicated flat/polished surfaces, depending on the desired optical out-coupling and in-coupling.

Generally, primary light, e.g. indicated by arrows 114, emitted from the emitting surface 112 of the LED 102 is imparted onto the bottom surface 108 of the plate 104. Some of the primary light 114 may pass into and through the bottom surface 108 of the plate 104, and into one or more wavelength-converting sections 106 to excite the wavelength-converting material therein to cause emission of secondary light 116. Some of the primary light 114 may pass into the bottom surface 108 of the plate 104 into one of the transmissive sections 107. The transmissive sections 107 may be optically transparent and may be configured to allow at least some of the primary light 114 imparted upon the plate 104 to pass through the plate 104 without being imparted on one of the wavelength-converting sections 106 and without conversion to secondary light, as indicated by arrow 118. Depending on the angular orientation of the LED 102, some primary light 114 may pass through a portion of one of the transmissive sections 107 and be reflected by an adjacent wavelength-converting section 106, as indicated by arrow 120, or may enter the adjacent wavelength-converting section 106 to excite the wavelength-converting material therein to cause emission of secondary light 116.

The pattern of one or more discrete wavelength-converting sections 106 and transmissive sections 107 may be configured to increase the interaction area between the primary light 114 emitted by the LED 102 and the wavelength-converting material of each section 106. In turn, an increase in interaction area may allow more primary light 114 from the LED 102 to scatter within the plate 104 and increase interaction path lengths between the primary light 114 and the wavelength-converting material, thereby improving conversion efficiency. In addition, an increase in interaction area may also allow a low concentration of activator ions (luminescent ions) in the wavelength-converting material, resulting in a reduction of ion-ion interactions, thereby increasing conversion efficiency. In addition, the wavelength-converting sections 106 may be arranged in a manner to provide desired performance with any angular distribution of primary light 114 emitted by the LED 102.

The secondary light 116 and some of the primary light 114 may pass through the top surface 110 of the plate 104 and may also pass through the diffuser 122. The diffuser 122 may be configured to mix the primary 114 and secondary light 116 from the plate 104 and provide output light 124 having a desired color uniformity. The output light 124 may be a white and/or narrow-band light, depending on the primary light and the phosphor composition of the wavelength-converting sections 106. It is to be understood that the output light 124 may be polarized or un-polarized. The diffuser 122 may be configured to reduce the angular color spread in the light output (primary and secondary light) from top surface 110 of the plate 104 compared to use of a plate 104 without the diffuser 122. In one embodiment, the index of refraction of the diffuser 122 is different from the index of refraction of the plate 104.

The diffuser 122 may be positioned a distance from the plate 104. For example, a bottom surface 126 of the diffuser 122 may be positioned a distance L₁ from the top surface 110 of the plate 104. The distance L₁ may vary. In one embodiment, the distance L₁ may range from 0.1 mm to 40 mm. In another embodiment, for example, the distance L₁ may range from 1.0 mm to 20 mm. The diffuser 122 may be configured to control the illumination pattern of the mixed light. Depending on the desired output or illumination patterns, such as intensity and/or various view angles, the diffuser 122 may include a material having a size, shape and/or refractive index chosen to allow reduced color angular spread of the light emitted from the top surface 110 of the plate 104 compared to the color angular spread in the absence of the diffuser 122. For example, the diffuser 122 may include a ground glass diffuser, holographic diffuser, or microlens diffuser. In addition, a polygonal/circular TIR or minor reflector may be used to perform color mixing.

As shown, the plate 104 may be formed separately from the LED 102 and may be coupled in a known manner to the LED 102 so that light from the light emitting surface 112 of the LED 102 passes through the bottom surface 108 of the plate 104. The plate 104 may be positioned a distance from the LED 102, and may be supported within the assembly 100 by any known means, including support from a portion of a housing (not shown) of the assembly 100.

The bottom surface 108 of the plate 104 may be positioned remotely from the emitting surface 112 of the LED 102 by a distance L₂. The distance L₂ may be set according to desired operating conditions and performance. In one embodiment, the distance L₂ may range from 0.1 mm to 3 mm. In another embodiment, for example, the distance L₂ may range from 0.5 mm to 1 mm. Positioning the plate 104 a distance from the LED 102 generally allows the plate 104 to be formed into a shape that may be different from the surface of the LED 102. For example, the plate 104 may include a plate, dome, or shell shape and/or dimension, wherein the surface of the plate 104 can be circular, ellipse, or free form. Preferably, plate 104 is a flat plate as shown in FIG. 1.

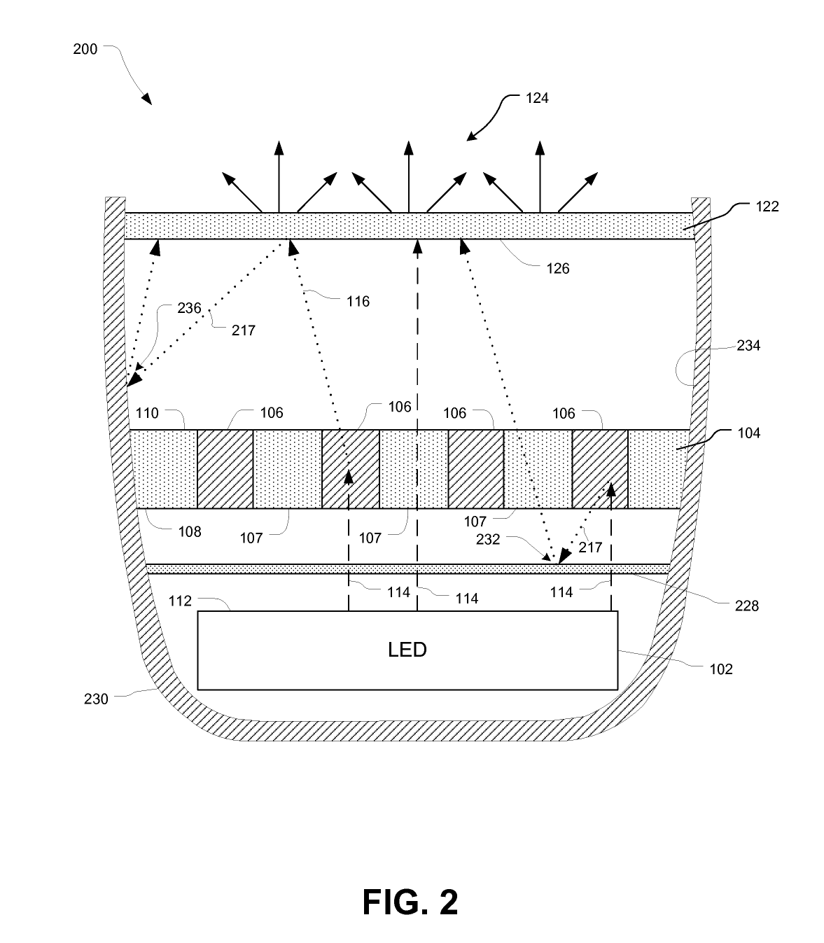

Turning now to FIG. 2, another embodiment of a wavelength-converted LED assembly 200 including structures (228, 230) configured to re-direct back scattering of light is illustrated in cross section. In the illustrated embodiment, the wavelength-converted LED assembly 200 includes the LED 102, wavelength-converting plate 104, and diffuser 122 of the assembly 100 of FIG. 1. Back scattering of light may be generally understood to mean light scattered back towards a direction from which the light was emitted. As shown, back scattered light, e.g. indicated by arrows 217, may include light directed away from the plate 104 and/or diffuser 122 in a direction towards the LED 102. As shown, the backscattered light 217 includes secondary light 116 in a direction toward the LED 102.

In one embodiment, the assembly 200 may include an optical filter 228 configured to selectively allow primary light 114 to pass through at least a portion of the filter 228 and to prevent secondary light 116, including backscattered secondary light 217, from passing through the filter 228 in at least direction toward the LED 102. The filter 228 may be further configured to reflect backscattered secondary light 217 in a direction away from the LED 102, as indicated by arrow 232. As shown, the filter 228 is positioned between the emitting surface 112 of the LED 102 and the bottom surface 108 of the plate 104. In another embodiment, the filter 228 may be directly coupled to the emitting surface 112 of the LED 102. In another embodiment, the filter 228 may be positioned between the top surface 110 of the plate 104 and bottom surface 126 of the diffuser 122. The optical filter 228 may include, for example, a dichroic filter, thin-film filter, and/or interference filter.

The assembly 200 may further include a reflector 230. The reflector 230 may be configured to reflect light such that a desired illumination pattern, such as a down light pattern, flood light pattern, etc., is emitted from the assembly 200. The reflector 230 may be configured to re-direct backscattered light 217 in a direction away from the LED 102. As shown, the LED 102, plate 104 and diffuser 122 may be enclosed within the reflector 230. The reflector 230 may include an internal surface 234 configured to reflect backscattered light 217 in a direction away from the LED 102, as indicated by arrow 236.

The wavelength-converting sections 106 and transmissive sections 107 may be formed in the plate 104 in a desired pattern and/or distribution, and the size (including depth and width) and shapes of the wavelength-converting sections 106 and transmissive sections 107 may vary depending on the application and intended outcome. For example, different color temperature and/or color uniformity can be achieved by varying the geometry and/or distribution of the wavelength-converting sections 106 and transmissive sections 107. Additionally, the fraction of converted light from the plate 104 can be controlled by varying size of each of the wavelength-converting sections 106 and transmissive sections 107, thereby improving color uniformity over angle and allowing optimization of efficacy and color.

FIG. 3, for example, diagrammatically illustrates the wavelength-converting plate 104 shown in FIG. 1 in perspective view. Internal features and/or surfaces are illustrated as hidden lines in FIG. 3. The plate 104 includes a pattern of discrete wavelength-converting sections 106 and transmissive sections 107 formed therein, wherein the wavelength-converting sections 106 and transmissive sections 107 are generally uniform in size and distribution. Each wavelength-converting section 106 may have a substantially rectangular cuboid (or strip) shape with a width W₁, depth D and length L and may be spaced equidistantly from an adjacent section 106 by an associated transmissive section 107. As shown, each section 106 may extend entirely through the plate 104 from the bottom surface 108 of the plate 104 to the top surface 110 of the plate 104. Similarly, each transmissive section 107 may have a substantially rectangular cuboid (or strip) shape with a width W₂, and may extend entirely through the plate 104 from the bottom surface 108 to the top surface 110 of the plate 104. In one embodiment, the width W₁ of a section 106 may range from 0.1 mm to 5 mm. In another embodiment, for example, the width W₁ of a section 106 may range from 0.5 mm to 1 mm. Similarly, in one embodiment, the width W₂ of a transmissive section 107 may range from 0.1 mm to 2 mm. In another embodiment, for example, the width W₂ of a transmissive section 107 may range from 0.5 mm to 1 mm.

FIG. 4 diagrammatically illustrates another embodiment of a wavelength-converting plate consistent with the present disclosure in perspective view. Internal features and/or surfaces are illustrated as hidden lines in FIG. 4. As shown, a wavelength-converting plate 404 may include a pattern of discrete wavelength-converting sections 406 and transmissive sections 407 formed therein, wherein a first set of wavelength-converting sections 406a may have a first width W₁ and a second set of wavelength-converting sections 406b may have a second width W₁′ different from the first width W₁. In an alternative embodiment (or additionally), the plate may include two or more sets of transmissive sections, each set having a different associated width.

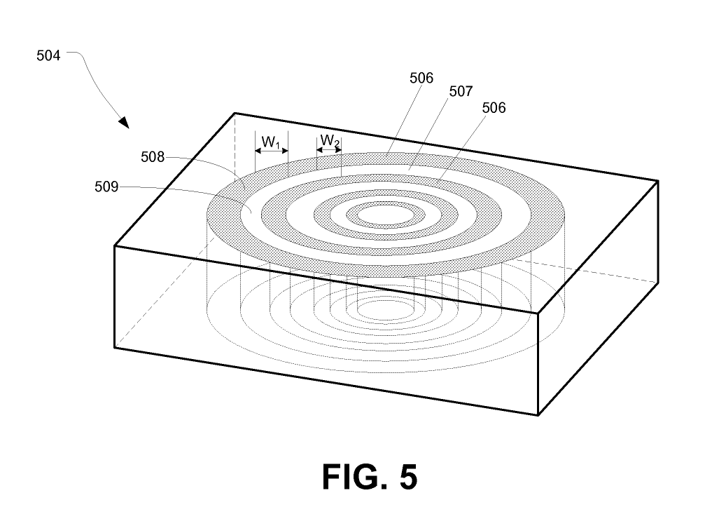

Although the wavelength-converting sections 106, 406 in FIGS. 3 and 4 are illustrated as having a substantially rectangular cuboid shape, it should be noted that the wavelength-converting sections may have a variety of shapes. Similarly, the transmissive sections 107, 407 may also have a variety of shapes. As shown in FIG. 5, for example, a wavelength-converting plate 504 consistent with the present disclosure may include a pattern including discrete wavelength-converting sections 506 and transmissive sections 507 formed in a concentric cylinder (or ring) configuration. In particular, each wavelength-converting section 506 may have a cylindrical shape and may be spaced equidistantly from an adjacent wavelength-converting section 506, wherein the sections 506 are separated from one another by cylinder-shaped transmissive sections 507. A wall 508 portion of each cylinder-shaped wavelength-converting section 506 may have a width W₁ and a wall portion 509 of each cylinder-shaped transmissive section 507 may have a width W₂. In one embodiment, the widths W₁ and W₂ may range from 0.1 mm to 2 mm. In another embodiment, the widths W₁ and W₂ may range from 0.5 mm to 1 mm. In the case of the ring configuration, if transmissive concentric cylinders are apertures in air or liquid, supporting structures are obviously needed but should have minimal impact on the operation. In one variation, transmissive concentric cylinders can be adequately emulated by a self-supporting dense array of holes or apertures in the pattern of concentric cylinders.

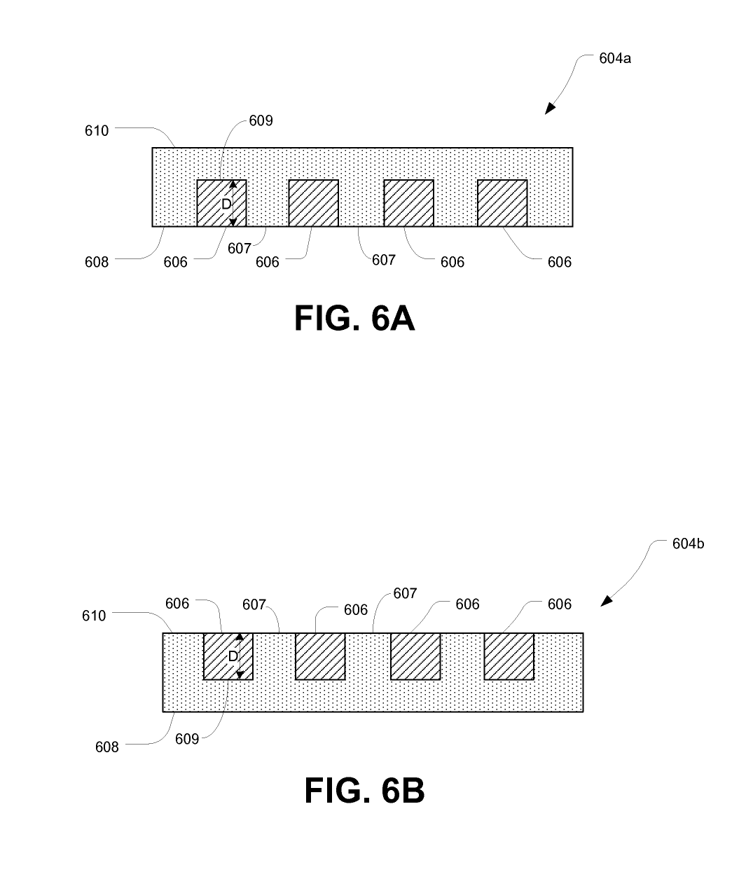

FIGS. 6A-6B diagrammatically illustrate other embodiments 604a, 604b of a wavelength-converting plate consistent with the present disclosure in sectional views. As shown in FIG. 6A, a wavelength-converting plate 604a may include one or more discrete wavelength-converting sections 606 and transmissive sections 607 with at least one of the wavelength-converting sections 606 extending from a bottom surface 608 of the plate 604a to an interior 609 of the plate 604a without extending entirely through the plate 604a. Alternatively, as shown in FIG. 6B, a wavelength-converting plate 604b may include a one or more discrete wavelength-converting sections 606 and transmissive sections 607 with at least one of the wavelength-converting sections 606 extending from a top surface 610 of the plate 604b to an interior 609 of the plate 604b without extending entirely through the plate 604b. With respect to both plates 604a and 604b, each of the wavelength-converting sections 606 may have a depth D measured from the bottom surface 608 (in the case of plate 604a) or the top surface 610 (in the case of plate 604b) to the interior 609, wherein the depth D is at least one percent the thickness of the plate 604a, 604b, and preferably at least 10 percent of the thickness of the plate, and more preferably at least 25 percent of the thickness of the plate.

Primary light emitted from an LED may be imparted onto the bottom surface 608 of the plates 604a, 604b. Some of the primary light may pass into and through the bottom surface 608 of the plates 604a, 604b, wherein some of the primary light may interact with and excite the wavelength-converting material of the wavelength-converting sections 606 to cause emission of secondary light. Some of the primary light may pass into the bottom surface 608 of the plates 604a, 604b into one of the transmissive sections 607. The transmissive sections 607 may allow at least some of the primary light imparted upon the plate 604a, 604b to pass through the plate 604a, 604b without conversion to secondary light. Additionally, depending on the angular orientation of the LED, some primary light may pass through a portion of one of the transmissive sections 607 and be reflected by, or pass into, an adjacent wavelength-converting section 606.

A light source including one embodiment of a wavelength-converting plate consistent with the present disclosure was simulated for color performance. Simulations were performed using LightTools® optical engineering and design software offered by Synopsys Inc. (Mountain View, Calif.). The light source included an LED array having an overall 30 mm by 30 mm Lambertian emitting surface, wherein the primary light emitted by the LED had a peak wavelength of 460 nm. Simulations were performed on wavelength-converting plates having patterns of wavelength-converting sections and transmissive sections consistent with the present disclosure formed therein. The wavelength-converting plate included wavelength converting sections composed of a YAG:Ce phosphor composition and transmissive sections composed of a ceramic material. The plate was positioned approximately 0.5 mm above the emitting surface of the LED. Additionally, a diffuser was positioned approximately 35 mm away from the top surface of the wavelength-converting plate. Each of the wavelength-converting sections had a substantially rectangular cuboid shape extending entirely through the plate and was separated from an adjacent section by an associated transmissive section, similar to the pattern shown in FIG. 3. Simulations were performed on a plate having transmissive sections having a width W₂ of approximately 0.5 millimeters (mm). Similarly, simulations were performed on additional plates including transmissive sections having widths of approximately 1.0 mm and 1.5 mm, respectively. In particular, Table 1 below shows the color performance results generated by the simulations.

TABLE 1
Color CIE

| Transmissive | | Near Field Irradiance | | Far Field Intensity | |
|---|---|---|---|---|---|
| Section Strip | CIE Color | | Standard | | Standard |
| Size (width) | Coordinates | Mean | Deviation | Mean | Deviation |
| 0.5 mm | Cx | 0.4273 | 0.0230 | 0.3669 | 0.0243 |
| | Cy | 0.5345 | 0.0234 | 0.4259 | 0.0433 |
| 1.0 mm | Cx | 0.4334 | 0.0232 | 0.3835 | 0.0212 |
| | Cy | 0.5346 | 0.0230 | 0.4445 | 0.0412 |
| 1.5 mm | Cx | 0.4289 | 0.0324 | 0.3791 | 0.0206 |
| | Cy | 0.5069 | 0.0363 | 0.4153 | 0.0338 |

As shown, the simulation results correlate to the width of each transmissive section (hereinafter referred to as “transmissive strip”). The near field irradiance and far field intensity were both measured. The irradiance (near field) is the optical power per unit area, as a function of the detector coordinates x and y. The intensity (far field) is the optical power per solid angle (e.g. view angle), a function of latitude and longitude (the light surface normal taken as north pole). The CIE color coordinates (Cx, Cy) are calculated based on both near field and far field distributions. The smaller the value (closer to zero) of the standard deviation, the more uniform the color.

As shown, the color performance (CIE color measurements) of the plate having 1.5 mm transmissive strips has a larger Cx deviation when compared to plates having 0.5 mm and 1.0 mm transmissive strips for near field measurements. In particular, the Cx standard deviation value for the near field measurement for the 1.5 mm transmissive strip plate was 0.0324 and the Cx standard deviation values for the near field measurements for the 0.5 mm and 1.0 mm transmissive strip plates were 0.0230 and 0.0232, respectively. Because the Cx standard deviation values for the 0.5 mm and 1.0 mm transmissive strip plates were smaller than the 1.5 mm transmissive strip plate, the 0.5 mm and 1.0 mm transmissive strip plates exhibit greater color uniformity than the 1.5 mm transmissive strip plate for near field irradiance.

Additionally, the color performance of the plate having 1.5 mm transmissive strips has a smaller Cx deviation when compared to plates having 0.5 mm and 1.0 mm transmissive strips for far field measurements. In particular, the Cx standard deviation value for the far field measurement for the 1.5 mm transmissive strip plate was 0.0206 and the Cx standard deviation values for the far field measurements for the 0.5 mm and 1.0 mm transmissive strip plates were 0.0243 and 0.0212, respectively. Because the Cx standard deviation value for the 1.5 mm transmissive strip plate was smaller than the 0.5 mm and 1.0 mm transmissive strip plates, the 1.5 mm transmissive strip plate exhibits greater color uniformity than the 0.5 mm and 1.0 mm transmissive strip plates for far field intensity.

Although the 0.5 mm transmissive strip plate exhibits the smallest Cx standard deviation value for near field irradiance and the 1.5 mm transmissive strip plate exhibits the smallest Cx standard deviation value for far field intensity, the 1.0 mm transmissive strip plate may be the optimal transmissive strip size. In particular, the color performance between the 1.0 mm transmissive strip plate and the 0.5 mm and 1.5 mm transmissive strip plates for near field irradiance and far field intensity, respectively, is minimal. As such, the 1.0 mm transmissive strip plate may be the optimal strip size.

A light source including another embodiment of a wavelength-converting plate consistent with the present disclosure was simulated for color performance. Simulations were performed using LightTools® optical engineering and design software offered by Synopsys Inc. (Mountain View, Calif.). The light source included an LED array having an overall 30 mm by 30 mm Lambertian emitting surface, wherein the primary light emitted by the LED had a peak wavelength of 460 nm. The wavelength-converting plate included wavelength converting sections composed of a YAG:Ce phosphor composition and transmissive sections composed of a ceramic material. The plate was positioned approximately 0.5 mm above the emitting surface of the LED. Additionally, a diffuser was positioned approximately 35 mm away from the top surface of the wavelength-converting plate. Simulations were performed on wavelength-converting plates having a pattern of discrete wavelength-converting sections and transmissive sections formed in a concentric cylinder configuration, similar to the embodiment of FIG. 5.

Simulations were performed on a plate having transmissive sections having a width W₂ of approximately 0.25 millimeters (mm). In particular, Table 2 below shows the color performance results generated by the simulations.

TABLE 2
Color CIE

| Transparent | | Near Field Irradiance | | Far Field Intensity | |
|---|---|---|---|---|---|
| Section Wall | CIE Color | | Standard | | Standard |
| (width) | Coordinate | Mean | Deviation | Mean | Deviation |
| 0.25 mm | Cx | 0.4466 | 0.0134 | 0.3942 | 0.0295 |
| | Cy | 0.5404 | 0.0121 | 0.4560 | 0.0473 |

According to one aspect of the present disclosure, there is provided a light module. The light module includes a solid-state light source configured to emit primary light from an emitting surface and a wavelength-converting plate having a bottom surface in opposed facing relationship to the emitting surface of the light source. The wavelength-converting plate includes a pattern of discrete wavelength-converting sections formed therein. Each wavelength-converting section includes wavelength-converting material for converting at least a portion of the primary light to a secondary light and is separated from an adjacent wavelength-converting section by an associated transmissive section. Preferably, each transmissive section is configured to allow the primary light to pass through the wavelength-converting plate without being imparted on any of the wavelength converting sections.

According to another aspect of the present disclosure, there is provided a wavelength-converting plate for a light module including a solid-state light source configured to emit primary light. The wavelength-converting plate includes a top surface and a bottom surface, wherein the bottom surface positioned in an opposed facing relationship to an emitting surface of the light source. The wavelength-converting plate includes a pattern of discrete wavelength-converting sections formed therein. Each wavelength-converting section includes a wavelength-converting material for converting at least a portion of the primary light to a secondary light and is separated from an adjacent wavelength-converting section by an associated transmissive section. Preferably, each transmissive section is configured to allow the primary light to pass through the wavelength-converting plate without being imparted on any of the wavelength converting sections.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A light module comprising:
a solid-state light source configured to emit primary light from an emitting surface; and
a wavelength-converting plate having a bottom surface in opposed facing relationship to said emitting surface of said light source, said wavelength-converting plate having a pattern of discrete wavelength-converting sections formed therein, each wavelength-converting section comprising a wavelength-converting material for converting at least a portion of said primary light into a secondary light, and each wavelength-converting section being separated from an adjacent wavelength-converting section by an associated transmissive section.

2. The light module of claim 1 wherein said wavelength-converting material is configured to emit secondary light from a top surface of said plate in response to said primary light being imparted thereon.

3. The light module of claim 1 wherein said associated transmissive section comprises translucent material whereby at least a portion of said primary light may pass through said associated transmissive section without conversion to secondary light.

4. The light module of claim 2 further comprising a diffuser having a bottom surface in opposed facing relationship to said top surface of said wavelength-converting plate, said diffuser being configured to collect and mix said primary and secondary light.

5. The light module of claim 1 wherein said wavelength-converting plate is positioned remotely from said light source.

6. The light source of claim 5 wherein a distance between said bottom surface of said wavelength-converting plate and said emitting surface of said light source is between about 0.1 mm and 3 mm.

7. The light source of claim 1 wherein at least one transmissive section has a width between about 0.1 mm to 2 mm.

8. The light source of claim 1 wherein at least one transmissive section has a width between about 0.5 mm to 1 mm.

9. The light module of claim 1 wherein said light source is selected from the group consisting of a light emitting diode (LED) and a laser diode.

10. The light module of claim 1 wherein said wavelength-converting sections and said associated transmissive section have a form of a rectangular cuboid.

11. The light module of claim 1 wherein said wavelength-converting sections and said associated transmissive section abut each other along their entire length.

12. The light module of claim 1 wherein at least one of said wavelength-converting sections extends partially between said top and bottom surfaces.

13. The light module of claim 12 wherein said at least one of said wavelength-converting sections extends from said bottom surface to an interior.

14. The light module of claim 12 wherein said at least one of said wavelength-converting sections extends from said top surface to an interior.

15. The light module of claim 1 wherein said wavelength-converting sections have a form of concentric cylinders.

16. The light module of claim 1 wherein said wavelength-converting sections and said associated transmissive section have a same width.

17. The light module of claim 1 wherein at least one of said wavelength-converting sections has a width that is different from a width of another of said wavelength-converting section.

18. The light module of claim 1 wherein said associated transmissive section is configured to allow said primary light to pass through said wavelength-converting plate without being imparted on any of said wavelength converting sections.

19. A wavelength-converting plate for a light module comprising a solid-state light source configured to emit primary light, said wavelength-converting plate comprising:
a top surface and a bottom surface, said bottom surface in opposed facing relationship to an emitting surface of said light source, said wavelength-converting plate having a pattern discrete wavelength-converting sections formed therein, each wavelength-converting section comprising a wavelength-converting material for converting at least a portion of said primary light into a secondary light, and each wavelength-converting section being separated from an adjacent wavelength-converting section by an associated transmissive section.

20. The wavelength-converting plate of claim 19 wherein said associated transmissive section is configured to allow said primary light to pass through said wavelength-converting plate without being imparted on any of said wavelength converting sections.

21. The wavelength-converting plate of claim 19 wherein said associated transmissive section comprises translucent material whereby at least a portion of said primary light may pass through said associated transmissive section without conversion to secondary light.

22. The wavelength-converting plate of claim 19 wherein said wavelength-converting sections and said associated transmissive section have a form of a rectangular cuboid.

23. The wavelength-converting plate of claim 19 wherein said wavelength-converting sections and said associated transmissive section abut each other along their entire length.

24. The wavelength-converting plate of claim 19 wherein at least one of said wavelength-converting sections extends partially between said top and bottom surfaces.

25. The wavelength-converting plate of claim 19 wherein said wavelength-converting sections have a form of concentric cylinders.

26. The wavelength-converting plate of claim 19 wherein said wavelength-converting sections and said associated transmissive section have a same width.

27. The wavelength-converting plate of claim 19 wherein at least one of said wavelength-converting sections has a width that is different from a width of another wavelength-converting section.
